(19) United States
(12) Patent Application Publication
(10) Pub. No.: US 2004/0219872 A1
(43) Pub. Date: Nov. 4, 2004

(54) Kitchen mallet

(76) Inventors: Anthony Di Bitonto, Brooklyn, NY (US); Mark Prommel, New York, NY (US); Mark Muenchigger, Brooklyn, NY (US)

Correspondence Address: SEYFARTH SHAW, 55 EAST MONROE STREET, SUITE 4200, CHICAGO, IL, 60603-5803, US

(21) Appl. No.: 10/428,574

(22) Filed: May 2, 2003

(51) Int. Cl. A22B 5/10

(52) U.S. Cl. 452/102

(57) ABSTRACT

The present invention provides a mallet or pounding tool having a cushioning member on a head of the tool adjacent a proximal end of a handle so that a resilient abutment surface and cushioned collar is provided to protect a user's hand during a pounding operation of the tool.

The present invention pertains to a kitchen utensil and in particular a kitchen mallet that provides for pounding and tenderizing.

### BACKGROUND

Pounding tools, such as kitchen mallets and meat tenderizers, are well known and generally have a handle and a head that include surfaces for pounding. The head may include a flat smooth surface for pounding meats or other food items. Another surface may be provided on the head having serrations or bumps formed thereon in order to provide for meat tenderizing when the serrated surface repeatedly strikes the meat or other food item. Some mallets are known which provide for both a pounding surface and a separate tenderizing surface. During the use of a tool for pounding, certain of these devices can be uncomfortable to hold or operate for long periods of time. Therefore, such devices have been improved by providing a gripping surface or rubberized handle. Such handles extend from the distal end of the handle along the majority of the length of the handle. These gripping surfaces have some resiliency in order to make the handle more comfortable to grip during operation of the tool. However, such devices fail to protect the user's hand during a pounding operation or use of the tool in an operation where the longitudinal axis of the handle is maintained generally vertical. Therefore, there is desired a pounding tool or mallet having means of protecting a user's hand when the mallet is operated during a tenderizing function and also a pounding function.

### SUMMARY

The present invention provides for a pounding tool for food comprising a handle having a distal end and a proximal end. In an embodiment, a head may be attached to the handle at its proximal end. In an embodiment, a cushioning member may be attached to the head adjacent to proximal end of the handle. In an embodiment, the cushioning member may be a resilient pad. In an embodiment, the resilient pad may be insert molded to the head and completely circumscribe the proximal end of the handle. In an embodiment, the resilient pad may be formed of a thermoplastic elastomer. In an embodiment, the resilient pad may be continuous and extends between the head and the handle and forms a collar therebetween. In an embodiment, the resilient pad completely circumscribes the handle. In an embodiment, the handle may be integrally formed with the head and the cushioning member may be molded over the handle and to the head to form a continuous resilient surface. In an embodiment, the handle may be formed as one piece with the head and the cushioning member may be molded over the handle and to the head. In an embodiment, the pounding portion is formed on the head opposite the handle and the cushioning member may be formed of a thermoplastic elastomer that may be insert molded to the handle and the head. In an embodiment, the cushioning member forms a circular pad on the head.

In an embodiment, the head includes a major surface providing a pounding portion and a serrated surface along a side of the head providing a tenderizing portion. In an embodiment, the pounding portion is formed on the head opposite the handle and the cushioning member may be formed on the head opposite the pounding portion. In an embodiment, the tenderizing portion forms a lip that extends beyond an edge of the head and the serrated surface may be generally parallel to the handle. In an embodiment, the head may be generally cylindrical having an annular side and the pounding portion is circular.

In an embodiment, the tool provides for dual food preparation functions including a first function of pounding and a second function of tenderizing. In an embodiment, the first function may be performed with the head oriented downward and the handle oriented generally vertically so that the cushioning member may be abutting the bottom of a hand, opposite a thumb and the cushioning member acts to absorb some of the force applied by the hand when pounding the head against a food item placed on a horizontal surface. In an embodiment, the second function may be performed with the head oriented upward and the handle oriented generally horizontally so that the cushioning member may abut a thumb and index finger of a hand gripping the handle. In an embodiment, the resilient pad may be provided on the handle and forms an extended grip. In an embodiment, the extended grip extends beyond the distal end of a the handle. In an embodiment, the extended grip may be formed by molding the resilient pad onto the distal end of the handle. In an embodiment, the extended grip forms a cylindrical shaft formed of a thermoplastic elastomer material that continuously covers the handle to provide a fully proportioned handle that is comfortable to grip in a hand. In an embodiment, a collar may be provided adjacent the cushioning member that may have a curved exterior surface and may be formed of one piece with the cushioning member.

A method of forming a pounding tool is provided comprising the steps of providing a metallic head having a handle protruding therefrom, forming a cavity in the head adjacent the handle, molding a thermoplastic elastomer material to the handle and the cavity to form a continuous cushioning member having a gripping surface and an abutment surface generally perpendicular to the gripping surface and a collar formed therebetween. The method may further comprise the step of attaching an insert to the handle and molding the thermoplastic elastomer material over the insert. The method may further comprise press-fitting the insert onto the handle.

### BRIEF DESCRIPTION OF THE DRAWINGS

For the purpose of facilitating an understanding of the subject matter sought to be protected, there is illustrated in the accompanying drawings an embodiment thereof, from an inspection of which, when considered in connection with the following description, the subject matter sought to be protected, its construction and operation, and many of its advantages should be readily understood and appreciated.

FIG. 1 is a plan view of the top of a mallet embodiment;

FIG. 2 is an inverted front elevation view of the mallet of FIG. 1;

FIG. 3 is a sectional view taken at line 3-3 in FIG. 2;

FIG. 4 is a right side elevation view of the mallet of FIG. 2; and

FIG. 5 is a sectional view taken at line 5-5 in FIG. 4.

### DETAILED DESCRIPTION

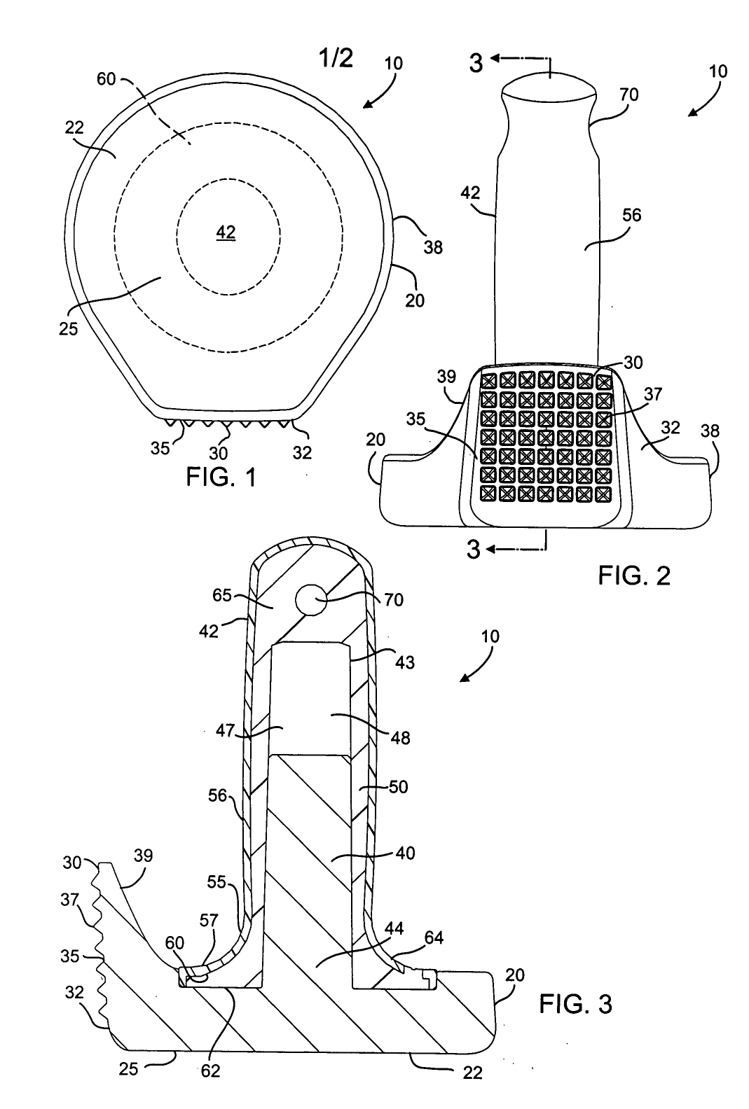

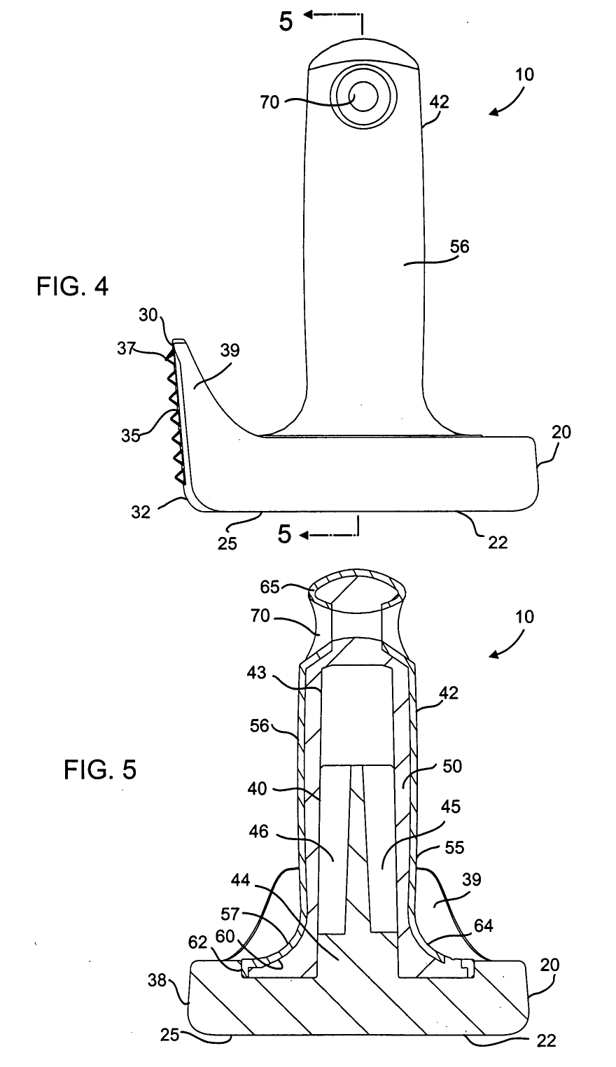

An embodiment is described with reference to FIGS. 1-5. A pounding tool or mallet 10 includes a head 20. In an embodiment, the head 20 is metallic, for example, formed of aluminum. In an embodiment, the head is cylindrically shaped, generally forming a puck-like member. The head 20 includes a major surface 22 that forms a pounding portion 25. The head 20 also includes a serrated surface 30 formed on a side 32 of the head 20 that forms a tenderizing portion 35. In an embodiment the pounding portion 25 and tenderizing portion 35 are both integrated on a single head 20. In an embodiment, the serrated surface 30 is formed of pyramidal shaped projections 37 forming a square-shaped grid pattern. However, the tenderizing portion 35 may be formed of other shaped projections 37, such as cones, and provide grids having other types of patterns. The serrated surface 30, in an embodiment, is formed in a plane that is perpendicular to the plane in which the pounding surface 25 is formed. The serrated surface 30 is formed along an edge 38 of the head 20. A majority of the edge 38 of the head is curved and forms a circular shape. However, in an embodiment, the serrated surface 30 is flat, but is continuous with the edge 38 (see FIG. 1). In an embodiment, the surface area of the serrated surface 30 is increased by forming a lip 39 that extends beyond the edge 38 of the head 20 to form the side 32. In an embodiment, the lip 39 is formed as one piece with the aluminum head 20.

Protruding from the head 20 is a handle 40. In an embodiment, the handle 40 is formed integrally with the head 20. In a preferred embodiment, the handle 40 is formed as one piece of aluminum continuous with the head 20. In an embodiment, the handle 40 forms a backbone upon which other surfaces and layers may be attached in order to provide a fully proportioned handle 42. However, in other embodiments the handle 40 may have the majority of its surfaces providing the fully proportioned handle 42 without further layers added thereto. The handle 40 includes a distal end 43 and a proximal end 44. In an embodiment, the handle 40 has voids 45, 46, 47, 48 formed therein in order to reduce the weight and absorb vibration of the tool 10. In an embodiment, however, the edges of the walls forming the voids 45, 46, 47, 48 form a periphery of the handle 40 that has a generally cylindrical in shape. In an embodiment, a sleeve 50 is press fit over the handle 40. In a preferred embodiment, the sleeve 50 is formed of a polymer material such as polypropylene.

In an embodiment, a cushioning member, such as a resilient pad 55 provides the exterior surface of the fully proportioned handle 42. In a preferred embodiment the resilient pad 55 forms a gripping surface 56 and also an abutment surface 57 formed over the sleeve 50. In an embodiment, the abutment surface 57 forms a circular pad 60 formed within a cavity 62 formed within the head 20. A collar 64 is also provided adjacent the circular pad 60. The collar 64 provides additional cushioning of the user's hand when operating the tool 10. In an embodiment, the collar 64 is formed integrally with the gripping surface 56 and the abutment surface 57. In an embodiment, the resilient pad 55 is one continuous surface forming the gripping surface 56, the abutment surface 57 and the collar 64. In an embodiment, the collar 64 has a curved exterior surface in order to comfortably receive the curved profile of the top or bottom sides of a user's hand thereon. This curved surface of the collar 64 and/or the circular pad 60 may act to protect and cushion a user's hand during pounding and/or tenderizing operations. It is to be understood that alternate embodiments may provide for a collar 64 that is formed separately from the gripping and abutment surfaces 56, 57 and may be formed having other shaped surfaces.

Therefore, it may be understood that when the mallet 10 is used as a tenderizing tool the fully proportioned handle 42 is grasped in a hand so that the tool 10 is in an orientation so that the head 20 is in an upward position, opposite that shown in FIGS. 2-5, with longitudinal axis of the handle oriented generally horizontally and a user's hand is oriented so that the thumb and index finger are adjacent the abutment surface 57 of the circular pad 60 and the collar 64. The tool 10 is then used by extending the user's arm and moving the tool 10 in an arc-like path so that the serrated surface 30 moves downward like a hammer to strike a food item such as meat on horizontal surface, such as a countertop (not shown). During such a tenderizing operation it should be understood that the gripping surface 56 formed by the resilient pad 55 allows for a user to comfortably hold the tool 10 and repeatedly pound the food item using the serrated surface 30, without stressing a users hand or causing blistering.

As discussed before, the tool 10 also includes a pounding portion 25 of the head 20 that allows for an additional function of the tool to provide for pounding of a food item. In order to operate the tool 10 in a pounding manner, the tool is re-oriented in a user's hand so that it is turned in an orientation, such as shown in FIGS. 2-5, with the head 20 in a downward position and the longitudinal axis of the handle oriented generally vertically. In such an orientation, the user's hand holds the fully proportioned handle 42 so that the bottom of a user's hand, the side of the hand opposite the thumb, is adjacent to the abutment surface 57 formed by the circular pad 60 and the collar 64, both formed by the resilient pad 55. The tool 10 may then be moved in a generally vertical path downward so that the major surface 22 of the head 20 will strike a food item placed on a horizontal support surface such as a countertop (not shown). During such a pounding operation, the user's hand will be compressed against the abutment surface 57 and the collar 64 and be cushioned and protected by the resilient pad 55 due to the orientation of the resilient pad 55 on the head 20 and forming the collar 64, both surrounding the proximal end 44 of the handle 40. The resilient pad 55 also reduces and dampens vibration.

It may be understood that while the preferred embodiment depicted in FIGS. 1-5 illustrate the resilient pad 55 forming a continuous surface that forms each of the gripping surface 56 of the handle 42, the collar 64 and the abutment surface 57 on the head 20, other embodiments may also be provided. For example, the abutment surface 57 may be formed by a resilient pad 55 or cushioning member that is separate from the handle 40, 42 or any cushioning member present on the handle 40, 42. As well, the cushioning member or resilient pad 55 forming abutment surface 57 may be formed on the head 20 in many different ways and may not have a portion of the sleeve 50 located between it and the metallic head 20. As well, the cushioning member or resilient pad 55 that forms the gripping surface 56 of the handle 42 may be formed in other manners than depicted in the FIGS. 1-5. For example, the handle 40 may have only selected areas on its surface where a cushioning member or resilient pad 55 is located. As well, the cushioning member or resilient pad 55 may be attached to the handle 40 without providing an sleeve 50 therebetween.

A preferred method of fabricating the tool of the present invention will now be described. The head 20 is provided having a cavity 62 formed therein adjacent the proximal end 44 of the handle 40. The handle 40 and head 20 are formed of one piece of aluminum. A sleeve 50 formed of polypropylene is pressed over the handle 40. A cushioning member or resilient pad 55 is molded over the sleeve 50. In a preferred embodiment, the resilient pad is formed of a thermoplastic elastomer, for example Santoprene®. In an embodiment, the thermoplastic elastomer is inserted molded over the sleeve 50 to form the gripping surface 56, the collar 64 and the abutment surface 57. In an embodiment, the distal end 43 of the handle 40 does not extend the entire length of the fully proportioned handle 42. In an embodiment, an extended grip 65 is formed by the sleeve 50 that is formed by a cylindrical shaft formed of a polymer material. In an embodiment the extended grip 65 may be formed by the sleeve 50 or by a separate portion of the thermoplastic elastomer. In an embodiment, a hole 70 is formed in the extended grip 65. The hole 70 may allow for the tool 10 to be hung on a rack or to have a string placed therethrough in order to hang the tool 10.

Therefore, it may be understood that the kitchen mallet or pounding tool 10 may be quickly fabricated that provides for the dual function of pounding and tenderizing while providing for comfortable gripping and abutment surfaces 56, 57 and cushioned collar 64 so that a user's hand may be protected during all pounding motions used during the full operation of the mallet or pounding tool 10 and where the abutment surface 57 is formed generally perpendicular to the gripping surface 56 having a curved collar 64 formed therebetween.

The matter set forth in the foregoing description and accompanying drawings is offered by way of illustration only and not as a limitation. While particular embodiments have been shown and described, it will be obvious to those skilled in the art that changes and modifications may be made without departing from the broader aspects of applicants' contribution. The actual scope of the protection sought is intended to be defined in the following claims when viewed in their proper perspective based on the prior art.

What is claimed is:

1. A pounding tool for food comprising:
a handle having a distal end and a proximal end;
a head connected to the handle at its proximal end; and
a cushioning member attached to the head adjacent to proximal end of the handle

2. The tool of claim 1 wherein the cushioning member is a resilient pad.

3. The tool of claim 2 wherein the resilient pad is insert molded to the head.

4. The tool of claim 2 wherein the resilient pad is formed of a thermoplastic elastomer.

5. The tool of claim 2 wherein the resilient pad is continuous and extends between the head and the handle and forms a collar therebetween.

6. The tool of claim 2 wherein the resilient pad completely circumscribes the handle.

7. The tool of claim 1 wherein the handle is integrally formed with the head and the cushioning member is molded over the handle and to the head to form a continuous resilient surface.

8. The tool of claim 1 wherein the handle is formed as one piece with the head and the cushioning member is molded over the handle and to the head.

9. The tool of claim 1 wherein the cushioning member is formed of a thermoplastic elastomer that is insert molded to the handle and the head.

10. The tool of claim 1 wherein the cushioning member forms a circular pad on the head.

11. The tool of claim 1 wherein the head includes a major surface providing a pounding portion and a serrated surface along a side of the head providing a tenderizing portion.

12. The tool of claim 1 wherein the pounding portion is formed on the head opposite the handle and the cushioning member is formed on the head opposite the pounding portion.

13. The tool of claim 11 wherein the tenderizing portion forms a lip that extends beyond an edge of the head and the serrated surface is generally parallel to the handle.

14. The tool of claim 1 wherein the head is generally cylindrical and the pounding portion is circular.

15. The tool of claim 11 wherein the side of the head is annular to form the generally cylindrical head.

16. The tool of claim 1 wherein the tool provides for dual food preparation functions including a first function of pounding and a second function of tenderizing.

17. The tool of claim 16 wherein the first function is performed with the head oriented downward and the handle oriented generally vertically so that the cushioning member is abutting the bottom of a hand, opposite a thumb, and the cushioning member acts to absorb some of the force applied by the hand when pounding the head against a food item placed on a horizontal surface.

18. The tool of claim 16 wherein the second function is performed with the head oriented upward and the handle oriented generally horizontally so that the cushioning member may abut a thumb and index finger of a hand gripping the handle so that a tenderizing portion formed on the head may be comfortably pounded against a food item placed on a horizontal surface.

19. The tool of claim 1 wherein the cushioning member is provided on the handle and forms an extended grip.

20. The tool of claim 19 wherein the extended grip extends beyond the distal end of a the handle.

21. The tool of claim 19 wherein the extended grip is formed by molding the resilient pad onto the distal end of the handle.

22. The tool of claim 19 wherein the extended grip forms a cylindrical shaft formed of a polymer material that continuously covers the handle to provide a fully proportioned handle that is comfortable to grip in a hand.

23. The tool of claim 1 wherein a collar is provided adjacent the cushioning member.

24. The tool of claim 23 wherein the collar is mounted to the proximal end of the handle.

25. The tool of claim 23 wherein the collar has a curved exterior surface.

26. The tool of claim 23 wherein the collar is formed as one piece with cushioning member.

27. A method of forming a pounding tool comprising the steps of:
providing a metallic head having a handle protruding therefrom;
forming a cavity in the head adjacent the handle;
molding a thermoplastic elastomer material to the handle and the cavity to form a continuous cushioning member having a gripping surface and an abutment surface generally perpendicular to the gripping surface and a collar formed therebetween.

28. The method of claim 27 further comprising the step of attaching a sleeve to the handle and molding the thermoplastic elastomer material over the insert.

29. The method of claim 27 further comprising the step of press-fitting the insert onto the handle.
